(19) United States
(12) Patent Application Publication
(10) Pub. No.: US 2004/0114193 A1
(43) Pub. Date: Jun. 17, 2004

(54) Photo sticker vending machine and method, photo sticker and photo sticker unit

(76) Inventors: Katsuyuki Inage, Kyoto (JP); Tetsuya Miwa, Kyoto (JP)

Correspondence Address: DICKSTEIN SHAPIRO MORIN & OSHINSKY LLP, 2101 L STREET NW, WASHINGTON, DC, 20037-1526, US

(21) Appl. No.: 10/662,332

(22) Filed: Sep. 16, 2003

(30) Foreign Application Priority Data
Sep. 18, 2002 (JP) 2002-271741

(51) Int. Cl. H04N 1/21; G06F 15/00

(52) U.S. Cl. 358/302; 358/1.15

(57) ABSTRACT

In the full-length image capture mode, a background of a captured image includes not only a background curtain but also the periphery. The image to be edited from multiple captured images is selected, and the brightness of the image is adjusted. After that, a range to be edited of the background is calculated from the background of the image through Chromakey processing. Then, the color corresponding to the degree of the brightness of the adjusted image is obtained from the stored colors of the background curtain. The calculated editing range of the background is then converted with the obtained color. As a result, the boundary of the background curtain and the periphery becomes inconspicuous, and the image having a good-looking background can be provided easily.

### CROSS-REFERENCE TO RELATED APPLICATIONS

This application claims priority under 35 USC §119 to Japanese patent application No. 2002/271,741 filed Sep. 18, 2002, the entire contents of which is incorporated herein by reference.

### BACKGROUND OF THE INVENTION

The present invention relates to a photo sticker printing apparatus and method, photo sticker and photo sticker unit. In particular, the present invention relates to a photo sticker printing apparatus and method, a photo sticker and a photo sticker unit, which allow the more preferable and easier editing of captured photographic images.

Conventionally, a photo sticker vending machine such as so-called “Print Club (Registered Trademark)” has been known for capturing an image of a user, combining, printing and providing the captured image with a prepared frame image on a sticker sheet, for example.

FIG. 1 is an elevation diagram showing a construction example of a conventional photo sticker vending machine 1. In FIG. 1, a background panel 2 is provided at a position facing toward and spaced from the photo sticker vending machine 1 by a predetermined distance. A hanging screen 4 is provided in front of the background panel 2. An image capturing portion 12 including a charge coupled device (CCD) 11 is provided in front of the photo sticker vending machine 1. A user 3 captures an image of himself/herself by using the CCD 11 in an image capturing space between the photo sticker vending machine 1 and the hanging screen 4. In the image capturing space, a ceiling member 5 is supported by the upper surface of the photo sticker vending machine 21 and the background panel 2. Additionally, a curtain and a side panel (not shown for the simplicity in description) are provided such that the inside of the image capturing space cannot be seen externally.

In the conventional photo sticker vending machine 1, the image capturing range of the CCD 11 is a range limited by an upper line 13-1 to a lower line 13-2. The hanging screen 4 is captured as the entire background. Therefore, the captured image can look nice with a clearer background. It is important to note that a horizontally boundary, not shown, exists in the image capturing range in FIG. 1.

With the hanging screen 4, a range available for graffiti, for example, can be limited in advance on a captured image with a uniform background color. Therefore, additional colors and/or patterns can be given and be edited more easily only on the background excluding the object of the image (see Japanese Patent Publication No. 3312165 (pages 10 and 11, FIG. 21)).

However, in the photo sticker vending machine 1, the imaging range of the CCD 11 is recently extended to a range limited by an upper line 14-1 and a lower line 14-2 such that any pose (including a whole body with arms outstretched) can be captured in accordance with the idea of the user 3. Thus, as shown in FIG. 2, an upper part 15-1, a lower part 15-2, a left side part 15-3 and a right side part 15-4 around the lower hanging screen 4 must be captured on the background of the image captured in the range limited by the upper line 14-1 and the line 14-2. When the captured image is printed as it is, the color of the hanging screen 4 is only printed on a part of the background. As a result, a sticker having an insufficient image is obtained. This is a disadvantage.

Furthermore, by using the editing functions, the surrounding part (that is, the periphery including the upper part 15-1, the lower part 15-2, the left side part 15-3 and the right side part 15-4) of the hanging screen 4 of the background of the image can be painted a color similar to the color of the hanging screen 4. However, it takes time to search for a color similar to the color of the hanging screen 4 and/or for painting finely. This is another disadvantage.

### BRIEF SUMMARY OF THE INVENTION

The invention was devised in view of these disadvantages. It is an object of the invention to more easily provide a sticker of an image having a nice-looking background.

According to one aspect of the invention, there is provided a photo sticker vending machine, including an image capturing unit for capturing an image of an object, a background providing unit located at the back of an object to be image captured for providing a background based on a selection and control of a user, a determining unit for determining whether or not the entire background of an image captured by the image capturing unit is an image of the background provided by the background providing unit, a converting unit for converting a part of the background (the periphery), based on the background color if the determining unit determines that the entire background of the image is not the image of the background color, a display control unit for controlling a display of the image converted by the converting unit, and a printing unit for printing the image converted by the converting unit on a photo sticker sheet.

The background providing unit may provide the multiple backgrounds having different colors or patterns based on selection and control by the user.

The photo sticker vending machine can further include a memory unit for storing the colors or patterns corresponding to the backgrounds provided by the background providing unit.

The photo sticker vending machine can further include an adjusting unit for adjusting brightness of the image. In this case, the converting unit converts a part other than the background image of the entire background of the image based on the brightness adjusted by the adjusting unit and on the background.

The photo sticker vending machine can further include a selecting unit for selecting an image to be edited from images captured by the image capturing unit, and an editing unit for editing the image, which is selected by the selecting unit. In this case, the determining unit determines whether or not the entire background of the image is to be edited, based on information supplied by the selecting unit. The color of the extracted, edited range of the background is converted to the color corresponding to the background curtain selected.

According to another aspect of the invention, there is provided an image printing method for a photo sticker vending machine, including an image capturing step for capturing an image of an object, a background providing step for providing a background at the back of an object to be image captured based on selection and control of a user, a determining step for determining whether or not the entire background of an image captured by the image capturing step is an image of the background provided by the background providing step, a converting step for converting an extracted edited range of the background to the color corresponding to the background curtain selected, a display control step for controlling a display of the image converted by the converting step, and a printing step for printing the image converted by the converting step on a sticker sheet.

According to the photo sticker vending machine and method of the invention, whether or not the entire background of an image is an image of a background provided based on selection and control of a user is determined. If the entire background of the image is determined to be the background image, the part, which is not the background image of the entire background of the image, is converted based on the background. Then, the display of the converted image is controlled, and the converted image is printed on a sticker sheet.

Therefore, according to the invention, even when the background image, such as a curtain image, is a part of the entire background of the image, an image having a good-looking background can be provided.

According to another aspect of the invention, a photo sticker is printed by a photo sticker printing method for a photo sticker vending machine, including an image capturing step for capturing an image of an object, a background providing step for providing a background at the back of an object to be image captured based on selection and control of a user, a determining step for determining whether or not the entire background of an image captured by the imaging capturing step is an image of the background provided by the background providing step, a converting step for converting an extracted, edited range of the background to the color corresponding to the background curtain selected, a display control step for controlling a display of the image converted by the converting step, and a printing step for printing the image converted by the converting step on a sticker sheet.

According to another aspect of the invention, there is provided a photo sticker unit used in a photo sticker vending machine, the machine including an image capturing unit for capturing an image of an object, a background providing unit located at the back of an object to be image captured for providing a background based on selection and control of a user, a determining unit for determining whether or not the entire background of an image captured by the image capturing unit is an image of the background provided by the background providing unit, a converting unit for converting an extracted, edited range of the background to the color corresponding to the background curtain selected, a display control unit for controlling a display of the image converted by the converting unit, and a printing unit for printing the image converted by the converting unit on a sticker sheet, the photo sticker unit including an identification information storing unit for storing identification information for identifying the photo sticker unit, wherein the photo sticker unit is available when the photo sticker vending machine authenticates the identification information stored in the identification information storing unit.

The identification information storing unit includes, for example, an IC tag (control tag) and a memory such as an IC card and stores a unique ID as identification information.

In this manner, the photo sticker unit can be used only when identification information is authenticated. Thus, only units produced for the photo sticker vending machine of the invention can be used, and non-genuine products are prevented from being used. Furthermore, when a barcode is given to the photo sticker unit, whether the unit is genuine or not may be determined based on the barcode.

As described above, according to the invention, a sticker of an image having a good-looking background can be obtained easily. Furthermore, according to the invention, a sticker having a preferred image can be obtained through easy operations without taking time and effort.

### BRIEF DESCRIPTION OF THE DRAWINGS

FIG. 1 is a diagram showing an arrangement of a conventional photo sticker vending machine;

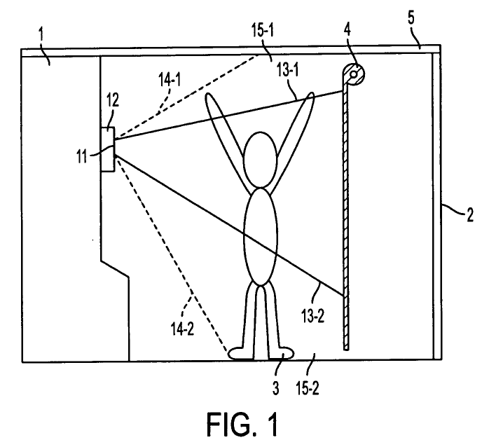

FIG. 2 is a diagram showing a display example of a monitor for image capturing;

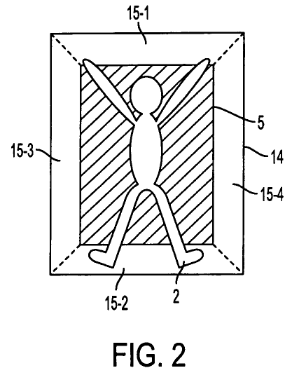

FIG. 3 is a perspective diagram showing an exemplary embodiment of a photo sticker vending machine according to the invention;

FIG. 4 is a perspective diagram showing an alternative exemplary embodiment of a photo sticker vending machine according to the invention;

FIG. 5 is a diagram showing an alternative perspective of the exemplary embodiment of the photo sticker vending machine in FIG. 3;

FIG. 6 is a plan view showing the photo sticker vending machine in FIG. 3.

FIG. 7 is a diagram showing an example of an operating panel in FIG. 3;

FIG. 8 is a block diagram showing the photo sticker vending machine in FIG. 3;

FIG. 9 is a block diagram showing a control device of the photo sticker vending machine of FIG. 8;

FIG. 10 is a flowchart for describing customer interaction with the photo sticker vending machine;

FIG. 11 is a flowchart for describing image capture processing performed at a step S2 in FIG. 10 in detail;

FIG. 12 is a diagram showing an exemplary screen of a monitor for image capturing, which is displayed at a step S11 in FIG. 11;

FIG. 13 is a diagram showing an exemplary screen of the monitor for image capturing, which is displayed at a step S12 in FIG. 11;

FIG. 14 is a diagram showing an exemplary screen of the monitor for image capturing, which is displayed at a step S16 in FIG. 11;

FIG. 15 is diagram showing an exemplary screen of the monitor for image capturing, which is displayed at a step S19 in FIG. 11;

FIG. 16 is a diagram showing an exemplary screen of the monitor for image capturing, which is displayed at a step S21 in FIG. 11;

FIG. 17 is a flowchart for describing editing processing performed at a step S3 in FIG. 7 in detail;

FIG. 18 is a flowchart for describing editing screen display control processing performed at a step S51 in FIG. 17 in detail;

FIG. 19 is a diagram showing an exemplary screen of a monitor for editing, which is displayed at a step S86 in FIG. 18; and

FIG. 20 is a diagram showing an example of a sticker sheet.

### DETAILED DESCRIPTION OF THE INVENTION

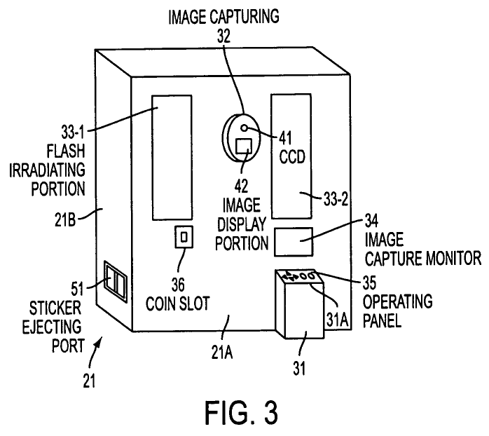

FIG. 3 is a perspective diagram showing an exemplary embodiment of a photo sticker vending machine 21 according to the invention.

An image capturing apparatus 32 projects from a vertical surface 21A of the photo sticker vending machine 21. A charge coupled device (CCD) 41 is provided on the front of the image capturing apparatus 32. An image display portion 42 is provided below the CCD 41. An image of an object is captured by the CCD 41, and the captured image (moving image) is displayed by the image display portion 42 in real time. For example, an image of a user (or an object) is captured by the CCD 41 in response to an instruction by the user. Then, the image of the user (object) is stored in the photo sticker vending machine 21 as a still image. Since the image display portion 42 is provided near the CCD 41, the user can capture an image of himself/herself by looking at the CCD 41 and by checking his/her image displayed on the image display portion 42 at the same time.

A flash irradiating portion 33-1 is provided on the left of the image capturing apparatus 32. A flash irradiating portion 33-2 is provided on the right of the image capturing apparatus 32. The flash irradiating portions 33-1 and 33-2 permeate flash light from an illuminating device within the photo sticker vending machine 21 and irradiate an object when an image of the object is captured by the image capturing apparatus 32 (or CCD 41).

An image capturing monitor 34 including a liquid crystal display (LCD) and a cathode ray tube (CRT) is provided below the flash irradiating portion 33-2. The image capturing monitor 34 displays various kinds of messages for guiding a user through the image capturing steps, for example, in accordance with the state in image capture processing. Since the image capturing monitor 34 displays a captured image, a user can select an image to edit (or to write graffiti) from displayed captured images. As described later, after a user finishes capturing images, the user can edit a captured image by moving to the back of the photo sticker vending machine 21 and by inputting desired text and figures to the captured image.

An operating portion 31 projects from the surface 21A below the image capturing monitor 34. An upper surface 31A of the operating portion 31 faces slightly diagonally upward. An operating panel 35 is provided on the upper surface 31A. A user can advance the image capture processing by manipulating various buttons on the operating panel 35.

A coin slot 36 is provided on the lower left of the surface 21A. The user inserts a predetermined amount of money to the coin slot 36 when the user uses the photo sticker vending machine 21, that is an image printing apparatus, for image capturing.

A sticker ejecting port 51 is provided at the bottom of a left side surface 21B of the photo sticker vending machine 21. The sticker ejecting port 51 ejects a sticker sheet including a captured image and edited image printed in a predetermined size thereon.

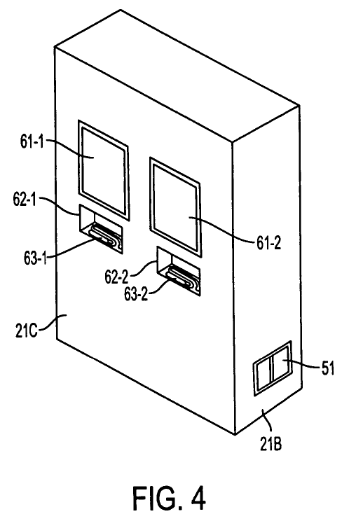

FIG. 4 is a perspective diagram showing a surface 21C corresponding to the opposite side of the surface 21A of the photo sticker vending machine 21. Here, the surface 21A is the front of the photo sticker vending machine 21 (that is, image printing equipment) and the surface 21C on the opposite side of the surface 21A is the back of the photo sticker vending machine 21.

Editing monitors 61-1 and 61-2 are horizontally aligned on the surface 21C of the photo sticker vending machine 21. A storing portion 62-1 is provided below the editing monitor 61-1. An input pen 63-1 is stored in the storing portion 62-1. The input pen 63-1 is used for editing an image by being pressed against the editing monitor 61-1 directly. Similarly, a storing portion 62-2 is provided below the editing monitor 61-2. An input pen 63-2 is stored in the editing monitor 61-2. The input pen 63-2 is used for editing an image by being pressed against the editing monitor 61-2 directly.

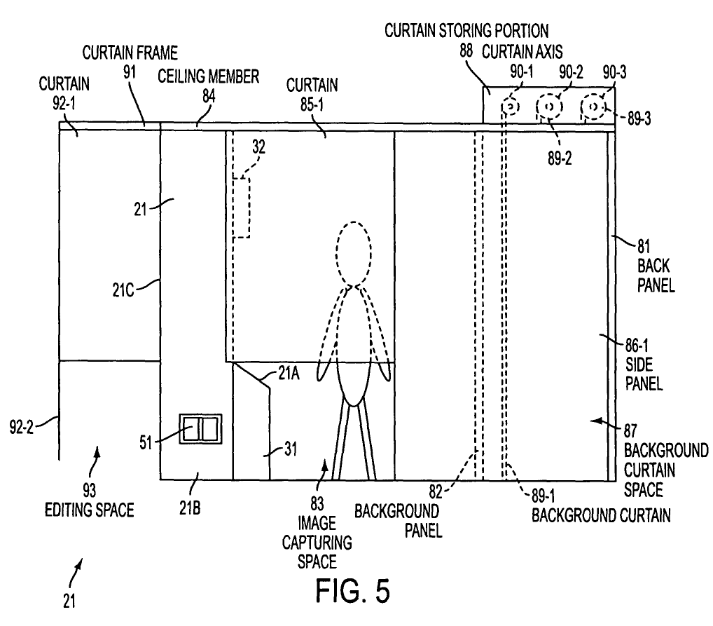

An image is captured by the image capturing apparatus 32 and is selected to edit. After a user finishes the image capture processing, Chromakey processing and/or conversion processing are performed on the selected image based on a background curtain 89 (FIG. 5). Then, the processed image is displayed on the editing monitors 61-1 and 61-2. Touch panels are stacked on the editing monitors 61-1 and 61-2. Thus, users can input desired letters and/or drawings onto displayed images by using the input pens 63-1 and 63-2.

The editing monitors 61-1 and 61-2 display buttons for selecting various editing tools together with the image to be edited. After the buttons are manipulated and the images are edited, the images edited in accordance with the user's input are displayed on the editing monitors 61-1 and 61-2.

The input pens 63-1 and 63-2 are compliant with the position detecting method (such as resistance film method and ultrasonic method) of the touch panels to be stacked on the editing monitors 61-1 and 61-2.

FIG. 5 is a diagram showing an alternative perspective of the photo sticker vending machine 21.

A back panel 81 faces toward and is spaced apart from the front (surface 21A) of the photo sticker vending machine 21 by a predetermined distance. A background panel 82 is provided in front of the back panel 81. An image of a user is captured in an image capture space 83 between the photo sticker vending machine 21 and the background panel 82. The image capture space 83 includes a ceiling member 84, a curtain 85-1 and a side panel 86-1. The ceiling member 84 is supported by the upper surface of the photo sticker vending machine 21 and the back panel 81. The curtain 85-1 and the side panel 86-1 prevent exposure of the inside of the image capturing space 83 to the outside.

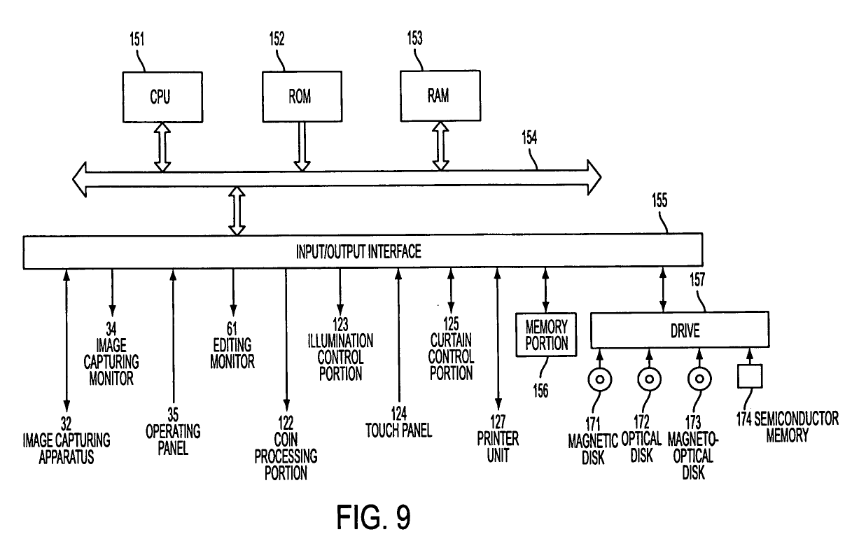

A background curtain space 87 is between the back panel 81 and the background panel 82. A curtain storing portion 88 is provided in the upper part (ceiling member 84) of the background curtain space 87. The curtain storing area 88 stores multiple background curtains 89-1 to 89-3. For example, the background curtain 89-1 may be a pink curtain. The background curtain 89-2 may be an yellow curtain. The background curtain 89-3 may be a pale blue curtain. The background curtains 89-1 to 89-3 are set in a memory portion 156 (FIG. 9) as roll curtains in different colors. The background curtains 89-1 to 89-3 are wrapped around respective curtain axes 90-1 to 90-3 and are stored in a curtain storing portion 88. The part of the ceiling member 84 above the background curtain space 87 is open such that the background curtains 89-1 to 89-3 can be pulled toward the background curtain space 87. The background curtains 89-1 to 89-3 are simply called background curtains 89 when they do not have to be handled separately.

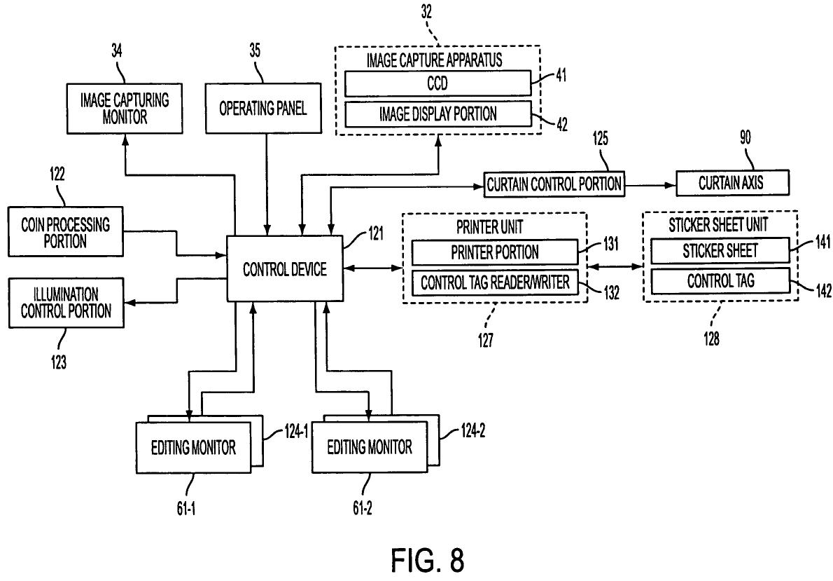

The background panel 82 is translucent. The curtain axis 90-1 is rotated by the curtain control portion 125 (FIG. 8) in response to a manipulation by a user in image capture processing, which will be described later, so that one (background curtain 89-1 in this case) of the background curtains 89-1 to 89-3 in the curtain storing portion 88 can be pulled out/down to the background curtain space 87. Thus, various kinds of background can be provided to the user. When all of the background curtains 89-1 to 89-3 are stored in the curtain storing portion 88, the color (such as white) of the back panel 81 is used as the background. Therefore, in this case, four kinds of background including the background curtains 89-1 to 89-3 and the back panel 81 are provided to users. As described later, Chromakey processing, conversion processing etc. are performed based on the background curtain 89 specified by a user. Then, an image to be edited is displayed on the editing monitors 61-1 and 61-2. A white background curtain 89 may be used instead of the back panel 81.

In FIG. 5, only three background curtains 89-1 to 89-3 are shown. However, any number of background curtains 89 may be stored. In the photo sticker vending machine 21, the curtain storing portion 88 is provided above the background curtain space 87, and the background curtain 89 is pulled out downward (to the background curtain space 87). However, the curtain storing portion 88 may be provided on the side panel 86-1 in the background curtain space 87, and the background curtain 89 may be pulled out horizontally.

An editing space 93 is provided at a position facing toward the surface 21C as a space for editing an image after a user finishes image capturing and moves to the space. In the editing space 93, a curtain 92-1 is mounted to a curtain frame 91 in order not to expose the inside to the outside. The curtain 92-1 is provided substantially on the same plane as the surface 21B. A curtain 92-2 faces toward and is spaced apart from the surface 21C by a predetermined distance. The curtain frame 91 is provided substantially on the same plane as that of the ceiling member 84.

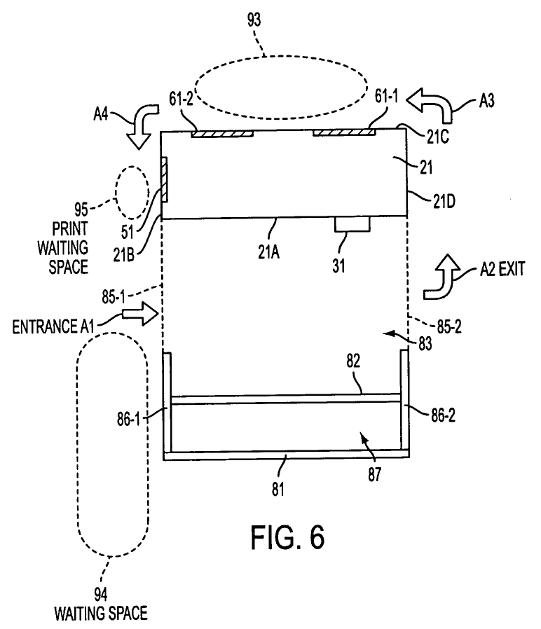

FIG. 6 is a plan view showing the photo sticker vending machine 21.

As shown in FIG. 6, a curtain 85-2 and a side panel 86-2 are provided in the right side surface 21D of the photo sticker vending machine 21 in order not to expose the inside of the image capturing space 83 to the outside like the surface 21B side. The inside (that is the part surrounded by the back panel 81, the ceiling member 84, the side panels 86-1 and 86-2) of the image capturing space 83 may be a monotonous (such as white) plane such that only the user's image can be extracted from images captured by the image capturing apparatus 32 by Chromakey processing, which will be described later.

The movement of a user from the beginning of image capturing to the receipt of a sticker sheet will be described with reference to FIG. 6.

A user enters to the image capturing space 83 as indicated by an open arrow A1 and performs image capture processing in the photo sticker vending machine 21 area. Therefore, when the image capture space 83 is used, a user desiring to use the photo sticker vending machine 21 must wait in an waiting space 94 by the side panel 86-1, for example, until the image capture space 83 becomes vacant.

After the user selects a predetermined number of images for editing and finishes the image capture, the user exits from the image capture space 83 as indicated by an open arrow A2. Then, the user moves to the editing space 93 at the back of the photo sticker vending machine 21 as indicated by an open arrow A3.

Here, the user who has been waiting in the waiting space 94 (who has been waiting for the image capture space 83 to become vacant) enters to the image capture space 83 after another user who has used the image capture space 83 moves to the editing space 93.

As described above, the editing monitors 61-1 and 61-2 can be checked from the editing space 93. The editing monitors 61-1 and 61-2 display images captured and selected in the image capture space 83. Therefore, the user can edit the captured images on the editing monitors 61-1 and 61-2. After the user finishes editing, the user moves to a print waiting space 95 as indicated by an open arrow A4. The print waiting space 95 is adjacent to the surface 21B of the photo sticker vending machine 21 (that is, image printing machine). The user waits until the edited image is printed on a sticker sheet and is supplied.

When the sticker sheet is supplied from the sticker ejecting port 51, the user receives the sticker sheet. Then, the use of the photo sticker vending machine 21 ends. The navigation of these movements is given through the image capture monitor 34, the editing monitors 61-1 and/or 61-2 or speakers, (not shown).

As described above, the space for image capturing, the space for editing and the space for waiting for the completion of printing are provided in front of different surfaces of the photo sticker vending machine 21. Thus, image capture processing, editing processing and printing processing can be implemented simultaneously, and the rate of serving the customers using the photo sticker vending machine 21 can be higher than that of the case where those kinds of processing are performed in one space. Furthermore, a set of users can take longer time for image capture processing and editing processing.

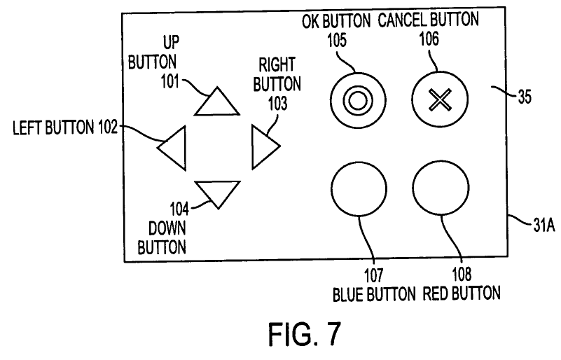

FIG. 7 is an enlarged diagram of the operating panel 35 in FIG. 3. An up button 101, a left button 102, a right button 103 and a down button 104 to be manipulated are provided on the left of the operating panel 35 for selecting one of various choices displayed on the image capture monitor 34. An OK button 105, a cancel button 106, a blue button 107 and a red button 108 are provided on the right of the operating panel 35. The OK button 105 is manipulated for determining one of various choices displayed on the image capture monitor 34. The cancel button 106 is manipulated for canceling the determined choice.

A touch pen, for example, is provided on the operating panel 31 as required for selecting one of various choices by being pressed on the image capture monitor 34 directly. The operating panel 35 sends a manipulation signal corresponding to an input by a user to a control device 121 (FIG. 8).

FIG. 8 is a block diagram showing the photo sticker vending machine 21 internally. The detailed description of the same elements as described above will be omitted below.

The control device 121 includes a personal computer and controls the entire operation of the photo sticker vending machine 21. More specifically, a central processing unit (CPU) 151 in the control device 121 performs processing based on programs stored in a read-only memory (ROM) 152 and/or the memory portion 156 (both in FIG. 9) including a hard disk.

When a user inserts a predetermined amount of money to the coin slot 36, a coin processing portion 122 detects and informs the control device 121 of the payment. The illumination control portion 123 emits flash light in response to an instruction from the control device 121 when the image capture apparatus 32 captures an object. The emitted light irradiates an object (that is, a user) through the flashing irradiating portions 33-1 and 33-2 in FIG. 3.

A touch panel 124-1 and a touch panel 124-2 are stacked on the editing monitor 61-1 and the editing monitor 61-2, respectively, is on the surface 21C of the photo sticker vending machine 21. The touch panels 124-1 and 124-2 output instructions from a user through the input pens 63-1 and 63-2 to the control device 121.

The curtain control portion 125 controls the driving of one of curtain axes 90-1 to 90-3 (curtain axes 90) in accordance with an instruction from the control device 121. Thus, the corresponding background curtain 89 can be pulled out to the background curtain space 87 and can be stored in the curtain storing portion 88.

A printer unit 127 includes a printer portion 131 and a control tag reader/writer 132. A sticker sheet unit 128 attached to the printer unit 127 includes a sticker sheet 141 and a control tag 142. The control tag 142 manages identification information for identifying the sticker sheet unit 128.

When edited image data is received from the control device 121, the printer portion 131 prints an image represented by the supplied image data on the sticker sheet 141 in accordance with the size and the number of divisions of the image selected by a user. Then, the printer portion 131 outputs the sticker sheet 141 to the sticker ejecting port 51.

The control tag reader/writer 132 reads out and outputs identification information stored in the control tag 142 by contact means or by non-contact means to the control device 121. The control device 121 determines whether or not the placed sticker sheet unit 128 is compliant with the photo sticker vending machine 21 based on the identification information supplied from the control tag reader/writer 132. Only if the control device 121 determines that the sticker sheet unit 128 is compliant, is the printer 131 enabled. In other words, the control device 121 manages identification information of sticker sheet units compliant with the photo sticker vending machine 21.

Thus, the use of non-genuine sticker sheets not compliant with the photo sticker vending machine 21 is prevented. The remaining area of the sticker sheet 141 is managed by the control tag 142. Whether the sticker sheet unit 128 is genuine or not may be checked based on the barcode printed on the sticker sheet unit 128.

FIG. 9 is a block diagram showing the control device 121 of the photo sticker vending machine of FIG. 8.

The CPU 151 performs processing in accordance with the program stored in the ROM 152 or with the program loaded from the memory portion 156 to the random access memory (RAM) 153. The RAM 153 may also have data required by the CPU 151 for performing the processing.

The CPU 151, the ROM 152 and the RAM 153 are connected to each other through a bus 154. The bus 154 is also connected to an input/output interface 155.

The input/output interface 155 is connected to the image capturing apparatus 32, the image capturing monitor 34, the operating panel 35, the editing monitors 61-1 and 61-2 (editing monitors 61), the coin processing portion 122, the illumination control portion 123, the touch panels 124-1 and 124-2 (touch panels 124), the curtain control portion 125 and the printer unit 127 shown in FIG. 8.

The memory portion 156 stores programs performed by the CPU 151, data of background images to be combined with an image of an object captured by the image capturing apparatus 32 and data of captured images. For example, as described later, in the image capture processing, a predetermined number of captured images can be processed, and the memory portion 156 stores data of the number of images corresponding to the number of captured images. Furthermore, as described later, in the display control processing for editing screens, the periphery of the background curtain 89 is converted to the color corresponding to the background curtain 89. The memory portion 156 stores multiple colors corresponding to the background curtains 89 in accordance with the brightness input by a user.

A drive 157 is connected to the input/output interface 155. A magnetic disk 171, an optical disk 172, a magneto-optical disk 173 or a semiconductor memory 174 are attached to the drive 157. Then, a computer program read therefrom is stored in the memory portion 156.

Next, the processing by the photo sticker vending machine 21 will be described with reference to flowcharts.

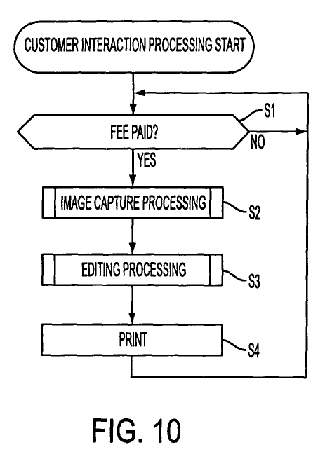

First of all, the entire processing of the photo sticker vending machine 21 for interacting with a customer (user) using the photo sticker vending machine 21 will be described with reference to a flowchart in FIG. 10.

At a step S1, the CPU 151 of the control device 121 determines whether a fee is paid or not, that is, whether a user starts to capture images or not based on the output from the coin processing portion 122. The CPU 151 waits until the CPU 151 determines that the fee is paid.

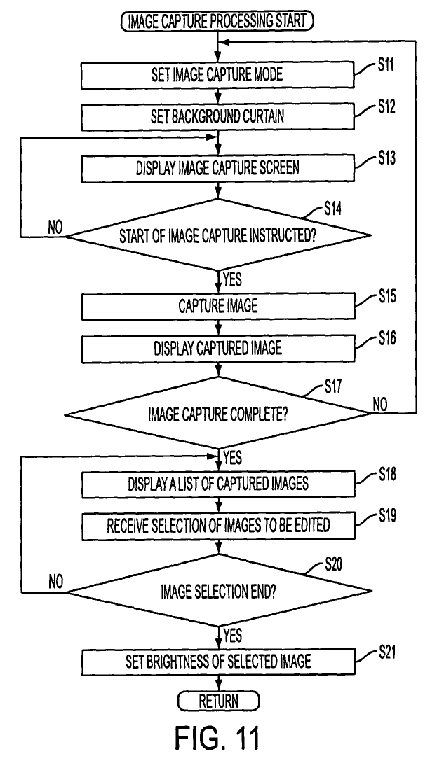

If the CPU 151 determines that the fee is paid at the step S1, the method goes to a step S2, where image capture processing in the image capture space 83 is performed. In other words, a predetermined number of images are taken repeatedly. When an image to be edited is selected from the obtained images, the image capture processing ends. The image capture processing performed at the step S2 will be described later in detail with reference to a flowchart in FIG. 11.

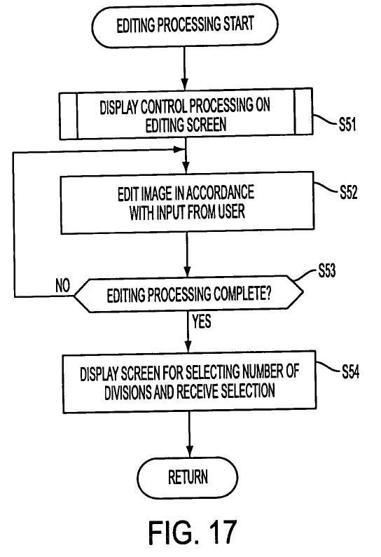

At the step S3, the CPU 151 performs editing processing for editing the captured image in accordance with the input from the user. The editing processing performed at the step S3 will be described later in detail with reference to a flowchart in FIG. 17.

At a step S4, the CPU 151 transfers image data of the image edited and created by the editing processing to the printer portion 131 of the printer unit 127 and causes the printer portion 131 to print the image. When the printing processing ends, the method goes to the step S1, and the above-described processing is performed repeatedly.

The processing shown in FIG. 10 is performed not only in a time-series manner in accordance with the described order but also in parallel in accordance with the state of use of the photo sticker vending machine 21. For example, when a second user starts image capturing in the image capture space 83 immediately after a first user finishes image capturing in the image capture space 83 and moves to the editing space 93, the image capture processing (processing for the second user) at the step S2 in FIG. 10 and the editing processing (processing for the first user) at the step S3 are performed in parallel. Similarly, the image capture processing, the editing processing and the printing processing at a step S4 can be performed in parallel in accordance with the respective states.

Next, the detail of image capture processing performed at the step S2 in FIG. 10 will be described with reference to the flowchart in FIG. 11.

At a step S11, the CPU 151 sets an image capture mode in accordance with the input from the user. More specifically, the CPU 151 displays a screen for setting the image capture mode on the image capture monitor 34 and controls the image capturing apparatus 32 in accordance with the input of the user onto the displayed screen to control the image capture mode. Two kinds of image capture modes including a zoom-in image capture mode and a full-length image capture mode can be set in the photo sticker vending machine 21.

In the zoom-in image capture mode, the degree and/or scaling of the image capturing apparatus 32 can be set so as to obtain an image capture range (angle of view) where an object (user) can be zoomed-in and be captured. In other words, the image capture range of zoom-in image capture mode is set so as not to capture the periphery of the background curtain 89 (that is, so as to capture only the background curtain 89) on the background of a captured image. For the image capture range of the full-length image capture mode, the angle and scaling of the image capturing apparatus 32 are set so as to obtain a wider image capture range corresponding to the full-length image capture of an object in various poses (such as standing with arms outstretched and on his/her hands) near the background curtain 89. Therefore, in the image capture range of the full-length image capture mode, the periphery of the background curtain 89 is captured on the background of the captured image.

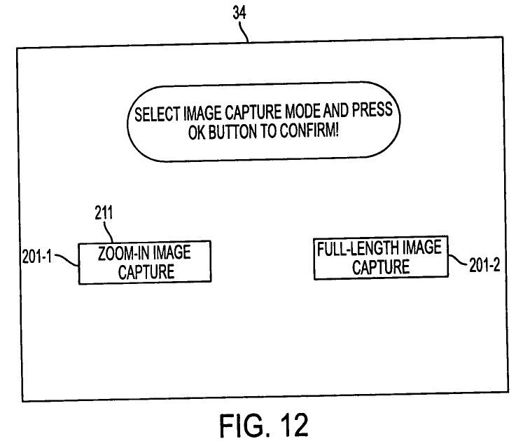

FIG. 12 is a diagram showing an exemplary embodiment displayed on the image capture monitor 34 at the step S11. In the example shown in FIG. 12, a message, “SELECT IMAGE CAPTURE MODE! AND PRESS TO CONFIRM” is displayed on the upper part of the screen for prompting the selection of the image capture mode. Image capture mode selection buttons 201-1 and 201-2 are displayed below the message. A message, “ZOOM-IN IMAGE CAPTURE”, is displayed on the image capture mode selection button 201-1. A user understands from the message that the current image capture mode is for image capture by zooming-in. A message, “FULL-LENGTH IMAGE CAPTURE”, is displayed on the image capture mode selection button 201-2. A user understands from the message that the current image capture mode is for capturing an image in full-length.

In FIG. 12, a cursor 211 is placed on the image capture mode selection button 201-1. In order to determine the image capture mode, a user can manipulates a left button 102 or a right button 103 on the operating panel 35 and places the cursor 211 on one of the image capture mode selecting buttons 201-1 and 201-2. Then, the user can manipulate the OK button 105 in the operating panel 35 and confirm the selection of the image capture mode selection button having the cursor 211 thereon. In this case, the image capture mode selection button 201-2 is selected.

After the image capture mode is selected and is confirmed, the CPU 151 sets the angle and scaling of the image capture apparatus 32 as described above in accordance with the full-length image capture mode corresponding to the image capture mode selection button 201-2.

Returning to FIG. 11, at step S12, the CPU 151 sets a background curtain based on the input from the user. More specifically, the CPU 151 displays the screen for setting a background curtain on the image capture monitor 34. The CPU 151 controls the curtain control portion 125 based on the input onto the displayed screen by the user and drives one of a plurality of curtain axes 90. Then, one of a plurality of background curtains 89 are pulled out into the background curtain space 87.

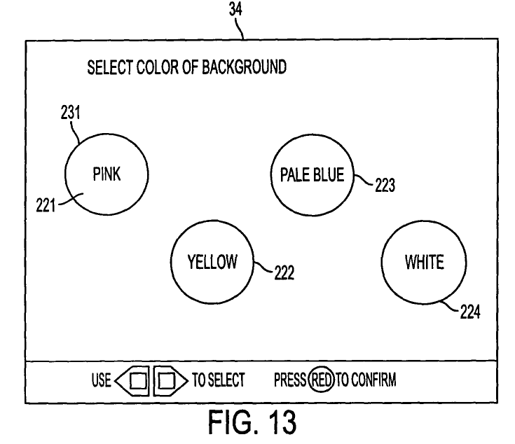

FIG. 13 is a diagram showing an exemplary screen displayed on the image capture monitor 34 at the step S12. In the example shown in FIG. 13, a message, “SELECT COLOR OF BACKGROUND”, is displayed on the upper part of the screen for prompting the selection of one of the background curtains 89. Background selection buttons 221 to 224 are displayed below the message. “PINK” is displayed on the background curtain selection button 221. A user understands from the letters that the background selection button 221 is a button for image capture with the pink background. Also, “YELLOW” is displayed on the background curtain selection button 222. “PALE BLUE” is displayed on the background curtain selection button 223, and “WHITE” is displayed on the background curtain selection button 224. A user understands from the labels that the background selection buttons 222 to 224 are buttons for image capture with the yellow, pale blue and white backgrounds, respectively.

For example, a user moves the cursor 231 by manipulating the left button 102 or the right button 103 on the operating panel 35 in accordance with the navigation message displayed at the bottom of the screen. Thus, the user can select a background curtain selection button by pressing the red button 108.

After the background curtain is determined, the CPU 151 controls the curtain control portion 125 to pull out one of the background curtains 89, corresponding to the selected background curtain selection button, into the background curtain space 87. In this case, for example, the background selection buttons and the background curtains 89 are associated in advance such that the background curtain selection buttons 221, 222, 223 and 224 can correspond to the background curtains 89-1, 89-2, 89-3 and 89-4, respectively.

Therefore, when a user specifies the background curtain selection button 231 (pink), the CPU 151 controls the curtain control portion 125 to drive the curtain axis 90-1 of the background curtain 89-1 corresponding to the background curtain selection button 231. Thus, the pink background curtain 89-1 is pulled out into the background curtain space 87. When the different background curtain 89-2 has been hung in the background curtain space 87, the curtain control portion 125 stores the different background curtain 89-2 into the curtain storing portion 88. Then, the curtain control portion 125 pulls out the background curtain 89-1 into the background curtain space 87. When the background curtain 89-1 instructed by the CPU 151 has been already hung in the background curtain space 87, the curtain control portion 125 controls the axis 90-1 to keep the background curtain 89-1 in the background curtain space 87.

When the background curtain selection button 224 (white) is selected, none of the background curtains 89 are pulled out, and the back panel 81 (white) is used as the background. In this case, the CPU 151 controls the curtain control portion 125 to store all of the background curtains 89 in the curtain storing portion 88 and to inhibit any of the background curtains 89 from being pulled out.

Returning again to FIG. 11, at step S13, the CPU 151 causes the image capture monitor 34 to display an image capture screen. On the image capture screen, a user's moving images (real view) captured by the CCD 41 and an image capture start button, to be manipulated for instructing the image capture to start, are displayed.

At step S14, the CPU 151 determines whether or not the start of image capturing is instructed by the user based on whether or not the image capture start button displayed on the image capture screen is manipulated. If it is determined that the start of image capturing has not been instructed, the method returns to the step S13, and the display of the image capture screen is continued.

On the other hand, at the step S14, when the CPU 151 determines that the start of image capturing is instructed by the user, the method goes to the step S15, the CPU 151 controls the image capturing apparatus 32 to capture an image of an object (or the user) in accordance with the set image capture mode (in this case, the full-length image capture mode) and image capturing conditions. For example, a message counting down to the image capturing is displayed on the image capture monitor 34, and, when the count reaches zero (0), that is, the image capture time, the CPU 151 controls the illumination control portion 123 to irradiate flash light to the object. Then, the CCD 41 captures an image of the object (by opening the shutter). The image data of the image obtained by image capture is stored in the RAM 153 or in the memory portion 156. Here, the image capture mode selected at the step S11 and the background curtain 89 selected at the step S12 are stored in association with the image data.

At a step S16, the CPU 151 displays the image captured immediately before on the image capture monitor 34 such that the user can check the image.

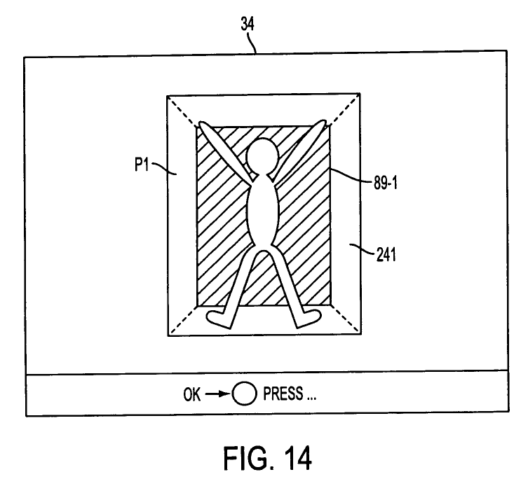

FIG. 14 is a diagram showing an exemplary screen displayed on the image capture monitor 34 at a step S16. An image P1 captured by the CCD 41 is displayed substantially at the center of the screen. The user can check the captured image P1 on the screen and press the OK button 105 in accordance with the navigation message displayed at the bottom of the screen.

As shown in FIG. 14, the image capture range in the full-length image capture mode is set wider. Thus, the periphery 241 of the background curtain 89-1 is captured on the background of the image P1, which results in a bad-looking image.

Returning to FIG. 11, at step S17, the CPU 151 determines whether image capture ends or not. Until the CPU 151 determines that the image capture ends, the method returns to the step S11, and the steps following the image capture mode selecting step are performed repeatedly. For example, a predetermined number of images to be captured is set in the photo sticker vending machine 21 in advance. When the remaining number of images to be captured reaches zero (0), the image capturing ends. When no time remains in the predetermined time limit, the image capturing ends abruptly.

At step S17, when the CPU 151 determines the end of the image capturing, the method goes to step S18, where the CPU 151 controls the display of the image capture monitor 34. Thus, a list of captured images is displayed on the image capture monitor 34. Then, the user is prompted to select an image to be edited in the editing processing.

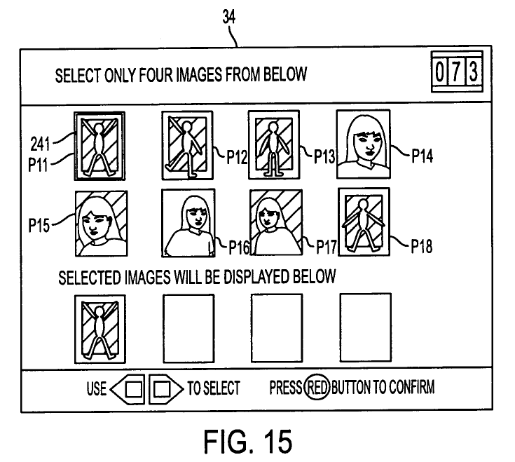

FIG. 15 is a diagram showing a screen example displayed on the image capture monitor 34 at step S18.

A message “SELECT ONLY FOUR IMAGES FROM LIST BELOW” is displayed on the upper part of the screen example shown in FIG. 15. The list of captured images (images P11 to P18) captured at step S15 is displayed therebelow. A message, “THE SELECTED IMAGES WILL BE DISPLAYED BELOW” is also displayed below the images P11 to P18. Four kinds of images selected as the image to be edited are displayed below the message. For example, the user moves the cursor 241 by manipulating the left button 102 or the right button 103 on the operating panel 35 and presses the red button 108 in order to select an image to be edited.

In the example in FIG. 15, the image P11 is selected as the image to be edited from the displayed list of the images P11 to P18. The user can select the other three-kinds of images continuously. The remaining time of the predetermined time limit for the selection of the image to be edited is displayed on the upper right corner of the screen. The remaining time is “73 sec.” in the example shown in FIG. 15.

Referring back to FIG. 11, the CPU 151 accepts the selection of the image to be edited at a step S19. Then, the size of the captured image is changed, and the image is stored in the memory portion 156 as an image to be edited. Here, the captured image is deleted. At a step S20, the CPU 151 determines whether the image selection ends or not. If the CPU 151 determines that the image selection does not end, the method returns to the step S18. Then the selection screen as shown in FIG. 15 is continuously displayed.

On the other hand, if the CPU 151 determines that the image selection ends at the step S20 since four images have been selected as the images to be edited, the method goes to a step S21. There, a brightness adjusting screen for adjusting the brightness of the images stored as the images to be edited are displayed on the image capture monitor 34.

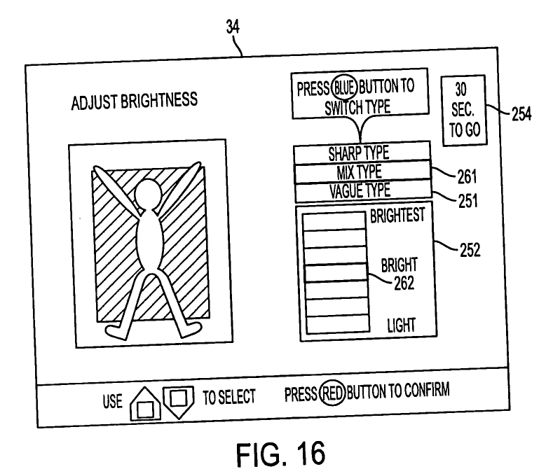

FIG. 16 is a diagram showing an example of the brightness adjusting screen displayed on the image capture monitor 34. In this example, the images stored as the images to be edited are displayed on the left of the screen. A type selecting portion 251 for selecting the degree of gamma correction for adjusting the brightness and a brightness selecting portion 252 for selecting the degree of brightness are displayed on the right.

The type selecting portion 251 includes three types of a sharpness correction: for obtaining a clear image by sharpening the sharp gradient of the gamma curve, a vague type for obtaining a vague image by making the gradient of the gamma curve flat and a mix type for obtaining the medium image. The user can press the blue button 107 on the operating panel 35 in accordance with the navigation message, “PRESS BLUE BUTTON FOR TYPE SWITCHING” on the upper part of the screen. Then, the user moves the cursor 261 and selects the type of gamma correction for adjusting the brightness.

In the brightness selection portion 252, seven degrees of brightness can be set including “BRIGHTEST” for the highest degree of brightness, “BRIGHT” for the medium degree of brightness and “LIGHT” for the lowest degree of brightness. The user can adjust the brightness by moving the cursor 262 by manipulating the left button 102 or the right button 103 on the operating panel 35 in accordance with a navigation message displayed at the bottom of the screen.

A remaining time indicator 254 indicates “30 SEC. TO GO” on the upper right corner of the screen. Thus, user understands that the remaining time of the image capture processing is 30 sec.

The CPU 151 adjusts the brightness corresponding to the gamma correction and the degree of brightness of the image to be edited in accordance with the input to the operating panel 35 (movement of the cursor 261 or 262). Then, the CPU 151 controls the image capture monitor 34 to reflect the adjustment to the editing image substantially at the center of the screen in real time. Thus, the user can adjust the editing image into preferred brightness. When the red button 108 is manipulated, the CPU 151 stores in the memory portion 156 image data of the editing image having adjusted brightness in accordance with the gamma correction and the degree of brightness in the present level, image data of the original image without brightness adjustment and a correction value for adjusted brightness. Then, the processing ends. After that, the processing at steps S3 and below in FIG. 17 is performed.

When the image capture processing ends, a message, “MOVE TO BACK OF MACHINE” is displayed on the shooting monitor 34 to navigate the user to move to the editing space 93. In accordance with the navigation, the user having captured images moves from the image capture space 83 to the editing space 93.

Next, the detail of the editing processing at step S3 in FIG. 10 will be described with reference to a flowchart in FIG. 17.

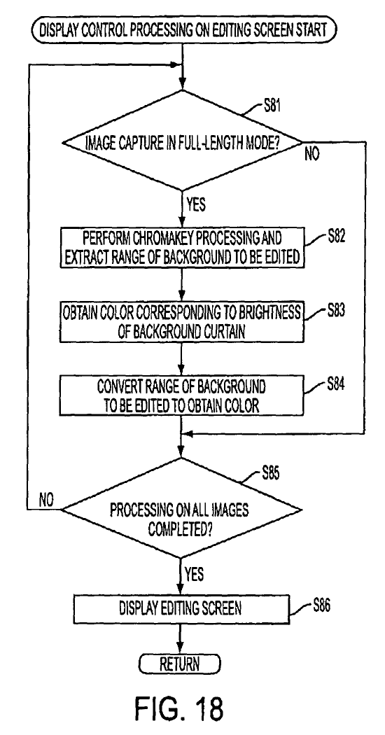

At step S51, the CPU 151 performs display control processing of the editing screen. The display control processing of the editing screen at step S51 will be described with reference to a flowchart in FIG. 18.

As described with reference to FIG. 14, in the frill-length image capture mode, the image capture range (angle of view) is set wider. Thus, the periphery 241 of the background curtain 89-1 is also captured on the background of the image P1. On the other hand, in the zoom-in image capture mode, the background curtain is captured on the entire background of an image. Therefore, the background of the image looks clearer and nicer than that in the full-length image capture mode. As described above, information on the image capture mode selected at the step S11 and on the background curtain 89 selected at the step S12 is stored in the memory portion 156 in association with the image data. At step S81 (FIG. 18), the CPU 151 determines whether the image to be edited is captured in the full-length mode based thereon. In other words, the CPU 151 determines whether the entire background of the image to be edited is the image of the background curtain 89 (only includes the image of the background curtain 89) or not.

If the CPU 151 determines that the image to be edited is captured in the full-length image capture mode at the step S81, the CPU 151 reads out image data of the original image to be edited at a step S82. The CPU 151 performs Chromakey processing on the read image data and extracts the range to be edited of the background. As described above, the captured image (angle of view) (that is, the part of the background curtain 89-1 that is captured) is set for each of the image capture modes in the photo sticker vending machine 21 in advance. Therefore, in the full-length shooting mode, the mask image corresponding to the periphery 241 of the background curtain 89-1 is provided such that the Chromakey processing cannot be performed on the part having the same color as that of the periphery 241 at the center part (the part other than the periphery 241).

In this way, in Chromakey processing at steps S82, an non-object part in the periphery 241 (excluding the background curtain 89-1) of the background curtain 89-1 is extracted from the image data of the image to be edited as the background range to be edited. Because the predetermined threshold value of the Chromakey processing changes in the edited image data having adjusted brightness, the accurate background range to be edited is not extracted. Therefore, in the Chromakey processing, the image data of the original image to be edited is used.

Next, at step S83, the CPU 151 obtains from the memory portion 156 the color (such as R, G and B information) corresponding to the adjusted brightness based on the correction value of the brightness adjusted at step S2 1 in FIG. 11 from the color (pink, in this case) of the background curtain 89-1 set at step S12 in FIG. 11. In this case, multiple colors corresponding to the background curtains 89 are stored in the memory portion 156 in accordance with the degrees of brightness. The CPU 151 reads out the color corresponding to the selected background curtain 89, and the read color may be adjusted to the color corresponding to the selected degree of brightness.

At step S84, the CPU 151 reads out the edited image (having adjusted brightness) from the memory portion 156. Then, the edited range of the background extracted at step S82 of the edited image is converted (painted) with the color obtained at step S83. Then, the range is stored in the memory portion 156 as the image of the edited range of the background.

Thus, the color of the extracted, edited range of the background is converted to the color corresponding to the background curtain 89-1 (called, background curtain color). As a result, the boundary of the background curtain 89-1 and the periphery 241 becomes inconspicuous.

As described above, the background curtain 89 in the photo sticker vending machine 21 includes the background curtains 89 in multiple colors. However, the background curtains 89 may have different kinds of pattern, such as a flower pattern. In that case, the color of the range to be edited of the background may be converted to the base color of the pattern. Alternatively, patterns may be stored in the memory portion 156, and the range to be edited of the background may be converted to one of the stored patterns.

On the other hand, if the CPU 151 determines that the image to be edited is not captured in the full-length image capture mode at step S81, that is, if the CPU 151 determines that the image to be edited is captured in the zoom-in image capture mode, the background curtain 89 is captured on the entire background of the image (that is, the periphery 241 of the background curtain 89-1 is not captured). Therefore, steps S82 to S84 are not necessary and are skipped.

At step S85, the CPU 151 determines if images exist that still require processing. If CPU 151 determines that images exist that still require processing control is returned to step S81. Then, the steps following the step S81 are repeated. If all of the images to be edited have undergone the processing at the step S85, the CPU 151 reads out the image to be edited of the converted background at a step S86. Then, the read image is superimposed on the image to be edited, and the edited screen is displayed on the editing monitors 61-1 and 61-2. In the zoom-in image capture mode, the image to be edited of the background is not converted and is stored at the step S84. Therefore, only the image to be edited is displayed.

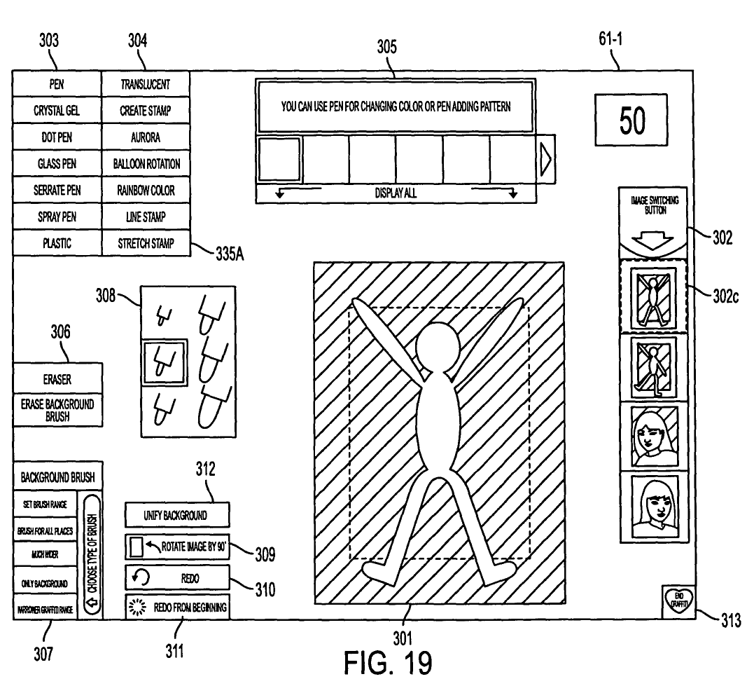

FIG. 19 is a diagram showing a display example of the edited image.

As described above, the editing monitors 61-1 and 61-2 are provided horizontally in parallel on the surface 21C of the photo sticker vending machine 21. The editing screen as shown in FIG. 19 is displayed on the monitors.

The editing screen displayed on the editing monitor 61-1 includes an image-to-be-edited display portion 301 displaying an enlarged image to be edited. A user selects the image to be displayed on the image-to-be-edited display portion 301 from images displayed in an image selecting portion 302 by moving a cursor 302C through an input pen 63-1. A list of four images selected to be edited in the image capture processing is displayed in the image selecting portion 302.

The range to be edited of the background (the periphery 241 of the background curtain 89-1, for example) of the image captured in the full-length image capture mode among the images displayed in the image-to-be-edited display portion 301 and the image selecting portion 302 are painted (or converted) to the background curtain color at the step S84 in FIG. 18. Therefore, as shown in the image-to-be-edited display portion 301, the background of the displayed image has the background curtain color. As a result, the boundary of the background curtain 89-1 and the periphery 241 is inconspicuous. In FIG. 19, the boundary of the background curtain 89-1 band the periphery 241 is indicated by a dashed-line for the convenience of the periphery fades seamlessly into the background.

Thus, the user does not have to edit by painting the periphery 241 of the background curtain 89-1 with the same color as that of the background curtain 89-1, which can save time and effort.

Buttons to be manipulated for selecting editing tools are displayed near the image-to-be-edited display portion 301. For example, a pen menu 303, a stamp menu 304 and a color selection menu 305 are displayed. The pen menu 303 is manipulated for selecting a pen tool for inputting a line and/or a letter on the edited image. The stamp menu 304 is manipulated for selecting a stamp tool for locating a predetermined stamp image on the edited image. The color selection menu 305 is manipulated for selecting a color of the line or letter input by the pen tool.

Furthermore, an eraser menu 306, a range adjustment menu 307 and a thickness menu 308 are displayed. The eraser menu 306 is manipulated for selecting an eraser tool for erasing graffiti having been input once. The range adjustment menu 307 is manipulated for selecting a background brush tool for locating a preferred texture on the background of an object and for selecting the range. The thickness menu 308 is manipulated for selecting the thickness of the pen tool.

Furthermore, the editing screen displays a switching button 309 and redo buttons 310 and 311. The switching button 309 is manipulated for switching the displaying direction (vertical or horizontal direction) of the image displayed on the image-to-be-edited display portion 301. The redo button 310 is manipulated for canceling an edit having input immediately before. The redo button 311 is manipulated for canceling all of the input edits. A background unifying button 312 is displayed above the redo button 311. The background unifying button 312 is manipulated for changing the color of the range to be edited of the background of the original, non-converted image obtained by the redo button 311 to the background curtain color. An end button 313 is displayed at the lower right corner of the editing monitor 61-1. The end button 313 is manipulated for finishing the editing processing and for starting to print.

When an image having the background in the background curtain color is displayed on the image-to-be-edited displayed portion 301, and when the redo button 311 is input through the touch panels 124-1 and 124-2, the CPU 151 reads out the image to be edited without the image of the range to be edited of the converted background thereon. When the displayed image is returned to the image having the background in the background curtain color, and when the background unifying button 312 is input through the touch panels 124-1 and 124-2, the CPU 151 displays the image of the range to be edited of the converted background on the image to be edited.

A time limit set for the editing processing is displayed at the upper right corner of the editing screen. The time limit is “50 sec.” in the example shown in FIG. 19.

In the above description, the range to be edited of the converted backgrounds is displayed on the image having the background in the background curtain color automatically. However, the range to be edited of the converted background may not be displayed until a user inputs the background unifying button 312 through the touch panels 124-1 and 124-2.

Referring back to FIG. 17, when an edit based on the tool selected on the editing screen is input through the touch panels 124-1 and 124-2, the CPU 151 edits the image selected to edit in accordance with the input from the user at a step S52. For example, when a predetermined pen tool is selected from the pen menu 303 and a letter is input to the image to be edited, the CPU 151 displays the image corresponding to the input letter on the image to be edited.

The CPU 151 determines whether the editing processing ends or not at step S53. If the editing processing does not end because the end button 313 is not manipulated, the method returns to step S52, and the above-described steps are performed again.

On the other hand, when the end button 313 is manipulated, or when the predetermined time limit is exceeded, the CPU 151 controls the editing monitors 61-1 and 61-2 to display a division (printing pattern) selecting screen for selecting the arrangement and size of the image to be printed on the sticker sheet 141 at a step S54. Then, the CPU 151 prompts the user to select a preferred number of divisions. In other words, predetermined numbers of divisions are set in the photo sticker vending machine 21 in advance such that a user can select a preferred printing pattern. When the number of divisions is selected by the user, the editing processing ends.

When the editing processing ends, the CPU 151 controls the editing monitors 61-1 and 61-2 to display a message for navigating to the print waiting space 95. The user moves to the print waiting space 95 in accordance with the displayed message and waits for the ejection of the sticker sheet from the sticker ejecting port 51.

After that, the method goes to step S4 in FIG. 7, and an edited and combined image is printed on the sticker sheet 141. In other words, the CPU 151 outputs the edited and combined image to the printer portion 131, and the image is printed on the sticker sheet 141 based on the data. The sticker sheet 141 having the printed combined image is ejected from the sticker ejecting port 51.

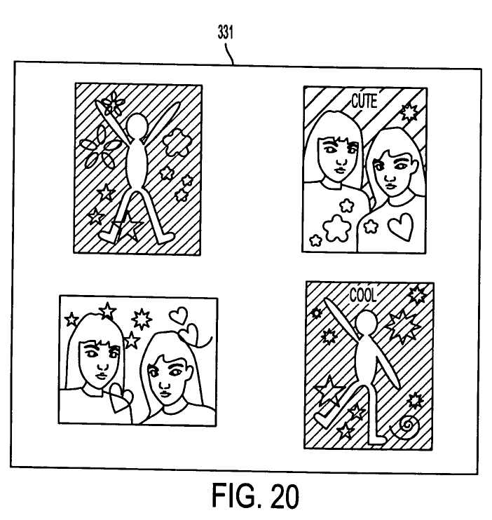

FIG. 20 is a diagram showing a sticker sheet example printed by the photo sticker vending machine 21 and ejected from the sticker ejecting portion 51.

As shown in FIG. 20, an edited image having letters and/or figures (graffiti) is printed on the sticker sheet 331 in accordance with the number of divisions (four divisions) set by the user.

The letters, “CUTE” and “COOL” and stamp images such as heart and star figures around the image of an object (people) or partially on the image of the object in the edited image on the sticker sheet in FIG. 20 are input by the user on the editing screen of the sticker sheet. In this way, a user can add preferred letters and images onto a captured image. The background of an object looks nice by having the background curtain 89 or by having the painted color corresponding to the background curtain 89 selected by the user.

This kind of sticker sheet is provided to the user using the photo sticker vending machine 21.

In this way, a user can obtain a sticker sheet having an image with a nice background without taking time and effort.

In the above description, the colors of the background curtains are set in advance, and the background curtain selected by the user is pulled out automatically. However, the background curtain may be pulled out by the user manually. In this case, the pulled background curtain may be detected, or the color may be detected from the background curtain captured on the image.

Furthermore, in the above description, the range to be edited of the converted background is displayed on the screens of the editing monitors 61-1 and 61-2. In this case, the image has the background in the background curtain color. However, in order to display the resulting captured image at step S16 in FIG. 11 on the image capture monitor 34, the image having the background in the background curtain color can be displayed through the same processing.

While the invention has been described and illustrated with reference to specific exemplary embodiments, it should be understood that many modifications and substitutions can be made without departing from the spirit and scope of the invention. Accordingly, the invention is not to be considered as limited by the foregoing description but is only limited by the scope of the appended claims.

What is claimed as new and desired to be protected by Letters patent of the United States is:

1. A photo sticker vending machine, comprising:
image capturing means for capturing an image of an object;
background providing means located behind said object for providing a background based on selection and control of a user;
determining means for determining whether said captured image includes said background provided by said background providing means and an additional image element;
converting means for converting a periphery of said captured image to include said additional image element;
display control means for controlling a display of the image converted by the converting means; and
printing means for printing the image converted by the converting means on a sticker sheet.

2. The photo sticker vending machine according to claim 1, wherein the background providing means provides multiple backgrounds having different colors and patterns based on selection and control by the user.

3. The photo sticker vending machine according to claim 2, further comprising:
memory means for storing the color and the patterns corresponding to the backgrounds provided by the background providing means.

4. The photo sticker vending machine according to claim 1, further comprising adjusting means for adjusting a brightness of the image, wherein said converting means further converts said periphery based on the brightness adjusted by said adjusting means.

5. The photo sticker vending machine according to claim 1, further comprising:
selecting means for selecting an image to be edited from a plurality of images captured by the image capture means; and
editing means for editing the image to be edited, and
wherein the determining means determines whether said background of said selected image is said background provided by the background providing means.

6. An image printing method for a photo sticker vending machine, comprising:
capturing an image;
receiving a user selection;
providing a background behind said object based on user selection;
determining whether said captured image includes said background at a periphery thereof;
a converting step for converting a part of said background at said periphery to product a converted image;
controlling a display of the converted image; and
printing the converted image on a sticker sheet.

7. A photo sticker printed by a photo sticker printing method, said method comprising:
capturing an object image;
providing a background of said object image based on a selection and control of a user;
determining whether said captured image includes one of said background provided and a periphery;
a converting step for converting said periphery of said captured image as said background provided;
a display control step for controlling a display of the image converted by the converting step; and
a printing step for printing the image converted by the converting step on a sticker sheet to produce said photo sticker.

8. A photo sticker vending machine, including a photo sticker unit comprising:
image capturing means for capturing an object image;
background providing means located behind said object for providing a background based on selection and control of a user;
determining means for determining whether said captured image includes one of said background provided and a periphery;
converting means for converting said periphery of said captured image;
display control means for controlling a display of the image converted by the converting means;
wherein the photo sticker unit includes identification information storing means for storing identification information for identifying the photo sticker unit; and
wherein the photo sticker unit is available when the photo sticker vending machine authenticates the identification information stored in the identification information storing means.

9. A photo sticker machine comprising:
a background apparatus, said background apparatus being adapted to display a first background during a first time interval and a second background during a second time interval;
a subject region, said subject region being adapted to receive an image subject during at least one of said first and second time intervals;
an imaging apparatus, said imaging apparatus being adapted to receive, during at least one of said first and second time intervals, an input image of a first portion of said image subject and a second portion of said background apparatus;
converting means for converting said input image into an output image, said output image including at least a portion of said input image;
determining means for determining an optional image element, said optional image element being adapted to be included in said output image by said converting means;
display control means for controlling a display of said output image; and
printing means for printing said output image on a sticker sheet.

10. The photo sticker machine according to claim 9 wherein said imaging apparatus comprises a camera.

11. The photo sticker machine according to claim 9 wherein said subject region is disposed between said imaging apparatus and said background apparatus.

12. The photo sticker machine according to claim 9 wherein said optional image element is included in a background region of said output image.

13. The photo sticker machine according to claim 9 wherein said background apparatus is adapted to display said first and second backgrounds according to an input received from a user.

14. The photo sticker machine according to claim 13 wherein said user comprises said image subject.

15. A photo sticker machine comprising:
a background apparatus adapted to display a first background during a first time interval and a second background during a second time interval;
a subject region adapted to receive an image subject during at least one of said first and second time intervals;
an imaging apparatus, said imaging apparatus being adapted to form an input image, said input image including a first image subject portion and a second background portion;
determining means for determining an additional image element;
converting means for converting said input image into an output image, said output image including a third image subject portion and a fourth background portion, said output image optionally including said additional image element;
display control means for controlling a display of said output image; and
printing means for printing said output image on a sticker sheet.

16. The photo sticker machine according to claim 15 wherein said additional image element is disposed within a fifth portion of said output image.

17. The photo sticker machine according to claim 16 wherein said fifth portion of said output image comprises a peripheral portion of said output image.

18. The photo sticker machine according to claim 16 wherein said fourth background portion comprises said fifth portion.
